(19) United States
(12) Patent Application Publication
(10) Pub. No.: US 2014/0219802 A1
(43) Pub. Date: Aug. 7, 2014

(54) Vertical Axis Wind\Tidal Turbine with Dynamically Positioned Blades

(71) Applicant: Viggo Lundhild, Sutton, MA (US)

(72) Inventor: Viggo Lundhild, Sutton, MA (US)

(21) Appl. No.: 14/245,591

(22) Filed: Apr. 4, 2014

Related U.S. Application Data
(63) Continuation-in-part of application No. PCT/US2011/054850, filed on Oct. 25, 2011.

(51) Int. Cl. F03D 3/06

(52) U.S. Cl. CPC F03D 3/068
USPC 416/147

(57) ABSTRACT

This invention is a Vertical Axis Turbine with blades [0012] which are continuously, accurately, and positively re-positioned during the rotation of the turbine shaft [0017] allowing the turbine to be more effective at transferring the kinetic energy in the moving air\water “flow” to the turbine shaft, it also allows for the turbine to have ancillary benefits that include: dynamic braking during emergency situations, high torque pitch setting for starting at low wind speeds, over speed control, and a zero torque setting. The blade positioning system is comprised of common Industrial Control System components, used to accurately, positively, and independently position turbine blades to be continuously at the optimum angle with respect to the flow direction.

### PRIORITY CLAIM

This application is a continuation-in-part patent application which claims the benefit to and priority from currently pending international stage patent application number PCT/US2011/054850 filed on Oct. 25, 2011.

### Technical Field

This invention is in the field of “Renewable Energy” and pertains to power generation, specifically Vertical Axis Wind Turbines (VAWT), Low Head River Turbines, Tidal and Ocean Current turbines. This invention involves the use of positioning devices and programmable processors to continuously, positively, and dynamically control the turbine blade angles during rotation of the turbine to enhance the performance of the above mentioned turbines.

### BACKGROUND ART

Non “Propeller” vertical axis wind turbines (VAWT's) have not been adopted as a viable alternative to the conventional horizontal orientated or “propeller turbines” (HWAT) due to the lower energy production, (my research indicates VAWT's produce approximately one half of the power or propeller type turbines when comparing turbines that have blades that sweep a similar area) higher starting torque(greater wind speed) requirement, and lack of turbine control resulting in structural failures during high load conditions. Previous attempts have been made with VAWT's which allow the blades to either fall against stops to limit the blade travel, or mechanically adjust the angle of the blade during the rotation of the turbine. These attempts have not been successfully implemented as the precise positive positioning of the blades [0012] is not achieved with these methods. This application of this invention would provide accurate, positive, and independent turbine blade [0012] control which would allow the turbine to require a substantially lower starting torque, provide higher energy production, allow for controlling output of the turbine, and allow the blades to be feathered (positioned directly into the wind\water “flow” direction to reduce or eliminate load on the turbine) during high load events thus protecting the turbine. The application of this invention dramatically improves the performance of these vertical axis turbines and would be ideally suited for Vertical Axis Wind Turbines, Tidal, Ocean Current, and River flow turbines where either vertical or horizontal axis of rotation is desired.

### DISCLOSURE OF INVENTION

Typical configurations of conventional VAWT's have, by the nature of their fixed blade configuration, blades which are in a counterproductive (high drag) position, relative to the flow direction, during many parts of the rotation of the turbine, and blades which are in a less than optimum angle to harness the energy in the flow with respect to the flow direction during many parts of the rotation of the turbine resulting in poor relative performance of the turbine. The one significant benefit of conventional vertical axis turbines is that they are omni directional. The intent of this invention to continuously correct the specific angle of each of the blades [0012] on the turbine, with respect to the flow direction, throughout the entire rotation of the turbine shaft [0017] to achieve optimum performance from each individual blade regardless of the flow direction, thus maintaining the omni directional benefit but adding significant performance capability. The proposed invention addresses this requirement by comparing each actual blade [0012] angles in real time, with respect to flow direction, to the desired optimum angle as determined by performance modeling for the specific turbine configuration and wind speed. Any error between the actual and desired position is corrected via a control loop output calculated by a programmable processor [0018] and delivered to the blade actuator [0013].

This turbine and control system is constructed with the use of these commercially available components; Absolute encoders, programmable processors, motor controllers, turbine blades, generators, and actuators. Absolute encoders provide a unique output signal for each increment (the resolution of each increment is determined by the characteristics of the encoder, the resolution used on the proof of concept model is 1024 unique increments for one rotation or an approximate resolution of ⅓rd of one degree) of the rotation of the encoder.

The frame of an absolute encoder is fastened to the main shaft of the turbine, along the center line axis of rotation, and the input shaft of the encoder is oriented and held in place by the flow direction of the wind or water (using a weather vane attached to the input shaft of the encoder). As the turbine rotates about its axis with the frame of the encoder, and the encoder input shaft is held stationary, a unique absolute signal is generated which corresponds to the position of the turbine frame with respect to the flow direction. (reference encoder [0010]). Encoders with identical characteristics to the reference encoder are fastened to the turbine frame on the centerline of each of the blade shaft [009] locations. The input shafts of these blade encoders [0011] are fastened to the blades in line with the axis of rotation of the blades.(blade encoders[0011]). As the blade is rotated around its axis (blade shaft [0009]) a unique absolute position reference is generated that indicates what each of the blade[0012] angles are at with respect to the turbine shaft [0017].

A programmable processor [0018] is used to store a large number of relationship curves that describe the desired variable relationships between the angle of each of the blades and the position of the turbine with respect to the direction of flow. The programmable processer is also used to store the actuator control logic. The control logic issues outputs to the actuators [0013]. These output commands contain both direction and magnitude. The control logic is based on well established PID (proportional, integral, derivative) feedback loop logic to provide accurate control of the blade actuators [0013].

With the actual position inputs from both the blades encoders [0011] and reference encoder [0010] it is then possible for the processor [0018] to compare the actual angless of the blades [0012] to the desired angle. Any delta between the actual and desired relationship is then corrected by the actuator control logic. The PID control logic incorporates the delta between desired and actual relationship and the speed of the turbine in rpm to determine the appropriate magnitude and direction of the control output. While the turbine shaft [0017] is rotating any delta between desired and actual angles of the blades [0012] will be continuously corrected. Each of the blades [0012] will be independently repositioned to follow the described optimum relationship regardless of the direction of the flow of the wind or water. The proof of concept model utilized an AMTEL programmable processor with C++ program coding. The relationship curves are stored in multiple date tables which are called based on variables such as flow speed, turbine rpm and turbine load. Multiple relationship tables are utilized to realize alternative references to blade angle relationships. i.e. the relationship required for the turbine starting mode is not the same as the relationship when the turbine is in the production mode and a different table is called to provide the appropriate curve.

### BRIEF DESCRIPTION OF THE FIGURES

FIG. 1 is a schematic illustration of the relationship of the components of the invention.

FIG. 2 is a schematic illustration of the approximate optimum blade angles relative to the flow direction for each of the 4 “phases” and 4 transition zones of a single blades rotation around the turbine for the “Starting” (maximum torque) mode.

FIG. 3 is a schematic illustration of the approximate blade [0012] angle to flow direction for each of the 4 “phases” and 4 transition zones of a single blades rotation around the turbine for the “Production” (maximum output) mode.

### DETAILED DESCRIPTION

The best mode for carrying out this invention would be to use a Programmable Logic Controller (PLC) of sufficient capacity to monitor and control the number of blades [0012] that a particular turbine is using. A single relationship curve would be used to control all of the blades for a specific operating mode (the curve is different for the start mode than the production or stop modes). The same relationship curve can be used for every blade by calling the starting point for each blade at a different point of the relationship curve. The PLC outputs would be controlling DC Motor drivers. The motor drivers would be controlling a DC Motor actuator directly connected to the turbine blade shafts via a gear reducer. The blade encoder acts as both a position indication and as a feedback input for the motor control loop. Vertical axis wind turbines from a 2 meter to 10 meter size are an ideal application where relatively low torque is exerted on the blade shafts. This system would also be well suited to turbines designed to harness tidal or ocean current flows as the flow speed is consistent and predictable and the turbine diameter can be configured to provide the ideal revolutions per minute to optimize the turbine output.

This system would apply to Vertical Axis Wind Turbines (VAWT's), Tidal, Ocean Current, or River turbines where it is desirable to orientate each blade to be in a specific position during the rotation of the turbine.

The positioning of the blades [0012] is accomplished by an actuator [0013] (electric worm gear motor) which is attached to one end of the blade shaft [0009] of the turbine blades [0012]. Each blade [0012] is capable of rotating in either direction to enable the accurate positioning required to attain the benefits described.

The actuator [0012] control is accomplished by creating an absolute relationship between the direction of the flow (either water or air), the turbine, and the turbine blades [0012]. A commercially available absolute encoder with characteristics similar to a “USDIGITAL MA3” is used to provide the flow direction and turbine reference position by the housing of the encoder being attached to the turbine shaft extension

and allowing the input shaft of the encoder to be orientated by the flow direction. (a weather vane attached to the input shaft orients itself to the flow direction and maintains the input shaft in a stationary position while the housing rotates along with the turbine, as the flow direction changes the input shaft is automatically realigned providing a new reference point). “Reference Encoder” [0010].

The turbine blade position is determined by using an encoder with the same characteristics as the reference encoder [0010] attached to the frame of the turbine with the input shaft of the encoder being oriented by the rotation of the turbine blade [0012]. These encoders each have their frames attached to the turbine frame to create the absolute physical relationship which is required for accurate positioning of the blades [0012]. “Blade Encoder” [0011]

With the absolute relationships determined by these encoders[0010′ 0011] (one for the flow\turbine, one for each of the blades) it is now possible to compare the actual angle of each of the blades [0012] to the position of the turbine shaft [0017]. Using a Programmable processor [0018] to store desired relationship curves for each of the blades and using the processor [0018] to compare the actual blade [0012] angle to the desired blade [0012] angle it is then possible to create a control output from the processer [0018] to continuously re-position the blades [0012] to continuously be at the desired angle as the turbine shaft

rotates.

Using this positioning system the blades [0012] are continuously re-positioned as the turbine shaft [0017] rotates to increase the duration of time that they are in the best angle, with respect to the flow direction of the wind or water, to produce energy, and can be used to decrease the time that the blades are in a counterproductive position thereby reducing drag which thereby contributes to the overall effectiveness of the turbine.

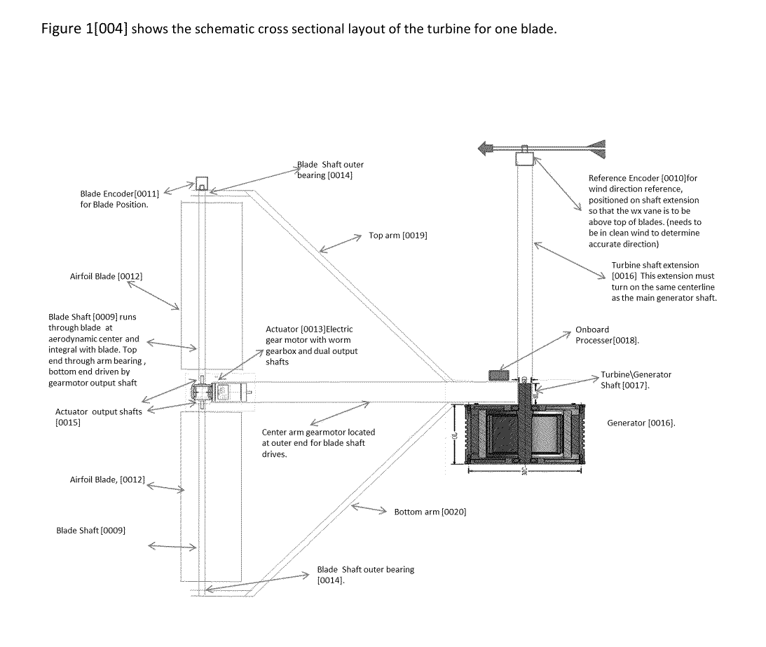

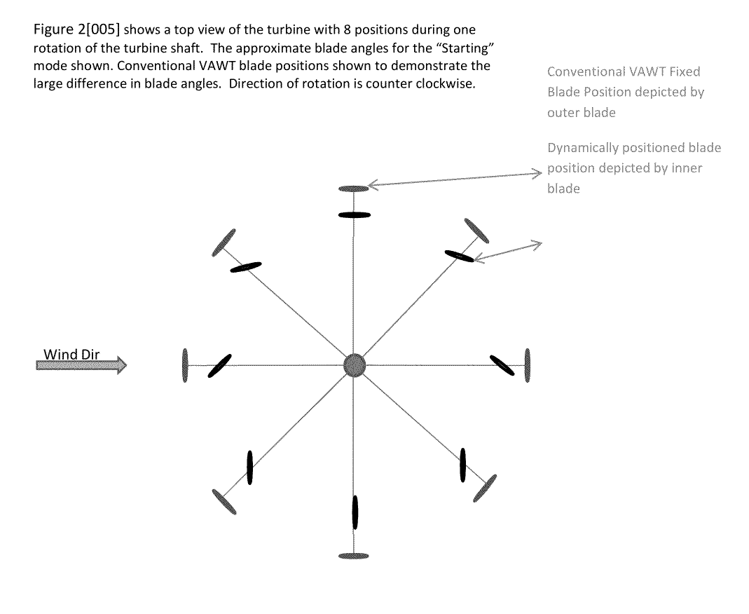

FIG. 1 is a schematic illustration of the relationship of the components of the invention. The blade encoder [0011] and reference encoder [0010] outputs provide the absolute actual position inputs for the processor [0018]. The actuator control logic is an output from the processor [0018]. The blades are mounted between a bearing [0014] at one end and an actuator shaft[0015] at the other end which allows them to be rotated. The blade shafts [0009] are located at the center of aerodynamic pressure of the blades [0012] to reduce load on the actuators [0013]. The encoders [0010, 0011] feed position information into the processer[0018], the processer[0018] evaluates the inputs, compares them to a desired curve, and produces an output in the form of an actuator control signal. The actuator [0013] accurately positions the blades as the turbine shaft [0017] rotates.FIG. 2 is a schematic illustration of the approximate optimum blade angles relative to the flow direction for each of the 4 “phases” and 4 transition zones of a single blades rotation around the turbine for the “Starting” (maximum torque) mode. Phase 1 is the upstream power phase, Phase 2 is the downwind drag phase, Phase 3 is the downstream power phase, and Phase 4 is the upwind drag phase. The schematic graphically illustrates the approximate angles of the blade with respect to the wind direction. For simplicity only 8 discreet positions are shown on this schematic. The actual resolution of the positioning system exceeds 1 degree. There are two blades [0012] shown for each of the 8 positions. The outer most blade indicates the angle of a conventional Vertical Axis Wind Turbine Blade and the inner blade indicates the approximate optimum angle when it is dynamically positioned. Between each “phase” there is a transition zone in which the blade is rapidly rotated from one phase to the next.

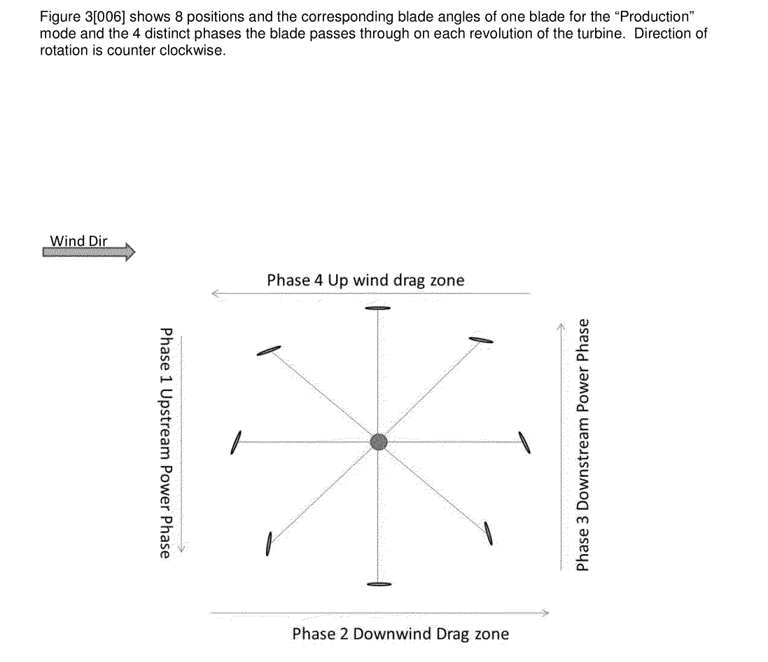

FIG. 3 is a schematic illustration of the approximate blade [0012] angle to flow direction for each of the 4 “phases” and 4 transition zones of a single blades rotation around the turbine for the “Production” (maximum output) mode. Phase 1 is the upstream power phase as the blade travels across, or 90 degrees to the wind direction. During this phase it is necessary to maintain a specific angle between the blade [0012] and the flow direction for as long as possible, Phase 2 is the downwind drag phase as the blade travels down wind. During this phase it is necessary to limit the amount of induced and parasitic drag produced by the blade [0012], Phase 3 is the downstream power phase as the blade travels across or 90 degrees to the wind, and Phase 4 is the upwind drag phase. The schematic graphically illustrates the approximate angles of the blade with respect to the wind direction. For simplicity only 8 positions are shown on this schematic. The actual resolution of the positioning system exceeds 1 degree. There are two blades shown for each of the 8 positions. The outer most blade depicts the position of a conventional Vertical Axis Wind Turbine Blade and the inner blades indicates the position when it is dynamically positioned.

### INDUSTRIAL APPLICABILITY

This invention is ideally suited to the Renewable Energy industry and lends itself to improving the performance of existing Vertical Axis Wind Turbine designs, Low Head river turbines, Tidal, and Ocean Current turbines. The market for these types of renewable energy sources is both large and international.

1-4. (canceled)

5. A Vertical Axis Turbine with blades which are continuously, positively, and accurately re-positioned during the rotation of the turbine shaft to be at a specified angle with respect to the wind or water “flow” direction throughout the complete rotation of the turbine. Adjustments are made to the blade angle at a minimum increment of one degree of rotation of the turbine shaft and the blade angle is positioned to within one degree of the optimum target angle.

6. A Vertical Axis Turbine as claimed in claim 1 in which the blade angles with respect to the flow direction can be positioned for the “Start” mode and allow the turbine to produce the maximum available torque at low wind speeds.

7. A Vertical Axis Turbine as claimed in claim 1 in which the blade angles with respect to the flow direction can be positioned for a “Production” mode and allow the turbine to produce the maximum output.

8. A Vertical Axis Turbine as claimed in claim 1 in which the blade angles with respect to the flow direction can be positioned so that each blade points directly into the wind direction and is maintained in this position allowing for zero torque on the turbine shaft.

9. A Vertical Axis Turbine as claimed in claim 1 in which the blade angles with respect to the wind direction can be dynamically adjusted to allow for speed (rpm) control of the turbine.

10. A Vertical Axis Turbine as claimed in claim 1 in which the blade angles with respect to the wind direction can be dynamically adjusted to allow for power output control of the turbine.
